(19) United States
(12) Patent Application Publication
(10) Pub. No.: US 2015/0115077 A1
(43) Pub. Date: Apr. 30, 2015

(54) SHREDDER AND SHEET-LIKE-OBJECT PROCESSING APPARATUS USING THE SAME

(71) Applicant: SAKAE CO., LTD., Tokyo (JP)

(72) Inventors: Yukihiro TAKEDA, Kodama-gun (JP); Koichi MATSUMOTO, Fujioka-shi (JP)

(73) Assignee: SAKAE CO., LTD., Tokyo (JP)

(21) Appl. No.: 14/524,258

(22) Filed: Oct. 27, 2014

(30) Foreign Application Priority Data
Oct. 28, 2013 (JP) 2013-223752

(51) Int. Cl. B02C 18/00; B02C 18/24

(52) U.S. Cl. CPC B02C 18/0007; B02C 18/24; B02C 2018/0069; B02C 2018/164
USPC 241/36; 241/167

(57) ABSTRACT

Provided is a shredder that prevents particles from jamming in a shredding mechanism, and shreds the sheet-like objects into such an extremely small size that the sheet-like objects cannot be reproduced. A shredding mechanism (3) includes blade drums (4, 5) in a pair, and a plurality of scraping members (6) for scraping off particles (1a) formed by shredding from an inside of recessed portions located between the cutter portions (4b, 5b) of each of the blade drums (4, 5). A control device (12) includes a determination unit (13) for determining a jam condition of the particles (1a) in the shredding mechanism (3) based on a load applied to a drive device (10) during idling of the shredding mechanism (3), which is carried out by driving the drive device (10) under a state in which the sheet-like object (1) to be shredded is not conveyed in the shredding mechanism (3).

### BACKGROUND OF THE INVENTION

1. Field of the Invention

The present invention relates to a shredder for shredding sheet-like objects. More particularly, the present invention relates to a shredder designed to shred sheet-like objects into such an extremely small size that the sheet-like objects cannot be reproduced, and to a sheet-like-object processing apparatus using the shredder.

2. Description of the Related Art

As shredders in the related art, shredders as described in Japanese Patent Application Laid-open No. 2000-354784 (Embodiment and FIG. 6) and Japanese Patent Application Laid-open No. 2009-131750 (Best Mode for carrying out the Invention and FIG. 1) have already been known.

The shredder disclosed in Japanese Patent Application Laid-open No. 2000-354784 (Embodiment and FIG. 6) includes entrapment preventing guide members for preventing particles to be discharged from spaces between rotary blades from being entrapped or fed back along outer surfaces of rotary shafts. The entrapment preventing guide members are interposed and fixed between the rotary blades. Prior to the interposition of the guide members between the rotary blades, each of the guide members is in a deformed state in which a facing distance between distal ends of a surrounding inner rim is large, that is, the surrounding inner rim is opened by a widthwise deformable cutout portion. In this manner, the guide members are inserted between the rotary blades through the space between the distal ends from an outer side of the rotary shafts, and then clamped. With this, the distance between the distal ends of the surrounding inner rim is reduced by the widthwise deformable cutout portion. In this closed state, the surrounding inner rim is maintained in a surrounding state, specifically, maintained to fit and cover an outer peripheral range that is at least equal to or larger than a semicircular region of corresponding one of the outer surface portions.

The shredder disclosed in Japanese Patent Application Laid-open No. 2009-131750 (Best Mode for carrying out the Invention and FIG. 1) includes a pair of roller cutters each including cutter discs and spacers that are stacked alternately to each other. The pair of roller cutters are engaged in parallel with each other so that the cutter discs on one side are fitted into spaces between the cutter discs on another side in a meshing state. Edge portions are formed so as to project in a radial direction from an outer peripheral surface of each of the cutter discs and the spacers, and in meshing portions therebetween, the edge portions of the cutter discs on the one side and the edge portions of the spacers on the another side are held in sliding contact with each other. With this, in the meshing portions, sheets that have been vertically shredded are cut in a manner of being torn apart upward and downward by the edge portions.

However, in the shredders of this type, shredding sizes of sheet-like objects are determined based on various security levels in accordance with demand from users, and shredding mechanisms corresponding thereto are employed. However, even at the highest security levels, a shredding size of the particles formed by shredders that are commercially available in the current market is at most 1.0 mm×5.0 mm (area of 5.0 mm²).

In recent years, according to a DIN standard set by a standard organization in Germany (DIN 66399, set in September 2012), out of seven security levels that are classified in accordance with shredding dimensions, Security Level 7 is specified as the highest level (shredding dimension: area of 5.0 mm² or less).

Thus, the above-mentioned shredding size satisfies Security Level 7 that is the highest level in the above-mentioned DIN standard. However, users are now strongly demanding that, in a case of executing a shredding process, for example, on highly confidential documents, those documents be shredded into such an extremely small size that contents of the documents cannot be reproduced from particles formed by the shredding process even when third parties try to read the contents from the particles.

In order to satisfy such demands, shredder manufacturers have investigated the possibility of shredding into particles of a smaller size. However, there are difficulties in manufacturing shredding mechanisms capable of shredding the sheet-like object into particles of a smaller size. In addition, it is necessary to solve problems that may occur in the case where the sheet-like object is shredded into particles of a smaller size, specifically, a problem in that finer particles are liable to jam between cutter elements of the shredding mechanism.

### SUMMARY OF THE INVENTION

It is a technical object of the present invention to provide a shredder and a sheet-like-object processing apparatus using the shredder, the shredder capable of preventing particles from jamming in a shredding mechanism at the time of shredding sheet-like objects, and shredding the sheet-like objects into such an extremely small size that the sheet-like objects cannot be reproduced.

According to a first technical feature of the present invention, there is provided a shredder, including: a shredding mechanism for shredding a sheet-like object, the shredding mechanism being provided in a midway of a conveying path through which the sheet-like object is inserted; a drive device for driving the shredding mechanism; and a control device for controlling the drive device, the shredding mechanism including: a first blade drum including cutter portions formed around a rotatable drum body, the cutter portions each including cutting blades formed at a predetermined pitch in a rotation direction of the rotatable drum body, the cutter portions being integrally formed by a cutting-out process through intermediation of recessed portions at a predetermined clearance along a direction of a rotary shaft of the rotatable drum body; a second blade drum including cutter portions formed around a rotatable drum body, the cutter portions each including cutting blades formed at a predetermined pitch in a rotation direction of the rotatable drum body, the cutter portions being integrally formed by the cutting-out process through intermediation of recessed portions at a predetermined clearance along a direction of a rotary shaft of the rotatable drum body, the first blade drum and the second blade drum being configured to mesh with each other in a manner that the cutter portions of the second blade drum bite into the recessed portions of the first blade drum, and that the cutter portions of the first blade drum bite into the recessed portions of the second blade drum; and a plurality of scraping members for scraping off particles formed by shredding in a meshing region between the first blade drum and the second blade drum in a pair from an inside of the recessed portions located between the cutter portions of the first blade drum and from an inside of the recessed portions located between the cutter portions of the second blade drum, the plurality of scraping members being arranged so as to bite into the recessed portions of the first blade drum and into the recessed portions of the second blade drum in a region out of the meshing region between the first blade drum and the second blade drum in a pair, the control device including a determination unit for determining a jam condition of the particles in the shredding mechanism based on a load applied to the drive device during idling of the shredding mechanism, which is carried out by driving the drive device under a state in which the sheet-like object to be shredded is not conveyed in the shredding mechanism.

According to a second technical feature of the present invention, in the shredder having the first technical feature, the plurality of scraping members each have a scraping surface conforming to a shape of a bottom surface of each of the recessed portions corresponding one of the first blade drum and the second blade drum.

According to a third technical feature of the present invention, in the shredder having the first technical feature, one or two of the plurality of scraping members are provided so as to face each of the first blade drum and the second blade drum, the one or two of the plurality of scraping members being regulated in position with respect to corresponding one of the first blade drum and the second blade drum by two position regulating members so that amounts of biting into the recessed portions of the corresponding one of the first blade drum and the second blade drum are regulated.

According to a fourth technical feature of the present invention, in the shredder having the first technical feature, the plurality of scraping members include: first partition members placed so as to remove the particles formed by shredding in the meshing region between the first blade drum and the second blade drum in a pair from the inside of the recessed portions of the first blade drum and from the inside of the recessed portions of the second blade drum, the first partition members being arranged in a plurality of stages in the region out of the meshing region between the first blade drum and the second blade drum in a pair so as to cover peripheries of the recessed portions of the first blade drum and peripheries of the recessed portions of the second blade drum; and second partition members placed so as to close gaps through which the particles formed by shredding in the meshing region between the first blade drum and the second blade drum in a pair enter between the first partition members, the second partition members being arranged in a plurality of stages in the region out of the meshing region between the first blade drum and the second blade drum in a pair so as to cover peripheries of the cutter portions of the first blade drum and peripheries of the cutter portions of the second blade drum.

According to a fifth technical feature of the present invention, in the shredder having the first technical feature, the drive device includes a drive source for driving the first blade drum and the second blade drum in a pair in the shredding mechanism, and the determination unit of the control device is configured to grasp the load applied to the drive device by detecting drive current of the drive source.

According to a sixth technical feature of the present invention, in the shredder having the first technical feature, the control device includes a maintenance determination unit for determining, based on results of determination by the determination unit, whether or not the jam condition of the particles in the shredding mechanism necessitates maintenance of the shredding mechanism.

According to a seventh technical feature of the present invention, in the shredder having the first technical feature, the drive device includes a drive source for rotating the first blade drum and the second blade drum in a pair in the shredding mechanism forward and reversely, and the control device includes a cleaning mode determination unit for determining, based on results of determination by the determination unit, whether or not the jam condition of the particles in the shredding mechanism necessitates execution of a cleaning mode for the shredding mechanism. In having the first technical feature, the control device executes a cleaning process including at least one reverse rotation of the drive source in a case where the cleaning mode needs to be executed.

According to an eighth technical feature of the present invention, there is provided, a sheet-like-object processing apparatus, including: a processing unit for processing a sheet-like object; and the shredder having the first technical feature, the shredder being configured to shred the sheet-like object in a case where a process by the processing unit has failed to be properly executed on the sheet-like object.

According to the first technical feature of the present invention, the shredder is capable of preventing the particles from jamming in the shredding mechanism at the time of shredding the sheet-like objects, and shredding the sheet-like objects into such an extremely small size that the sheet-like objects cannot be reproduced.

According to the second technical feature of the present invention, a scraping action by the scraping members can be performed over a wider range than that in a case where this configuration is not provided.

According to the third technical feature of the present invention, positional regulating accuracies of the scraping members with respect to the blade drums can be more satisfactorily maintained than those in a case where this configuration is not provided.

According to the fourth technical feature of the present invention, at the time of shredding the sheet-like objects, the jam of the particles in the shredding mechanism can be more reliably prevented, and hence shredding performance of the shredding mechanism can be maintained over a long time period.

According to the fifth technical feature of the present invention, the jam condition of the particles in the shredding mechanism can be easily determined with a simple configuration.

According to the sixth technical feature of the present invention, based on the jam condition of the particles in the shredding mechanism, whether or not the maintenance is needed can be more easily determined than in a case where this configuration is not provided.

According to the seventh technical feature of the present invention, in comparison with a case where this configuration is not provided, by executing the cleaning process when necessary depending on the jam condition of the particles in the shredding mechanism, the jam condition of the particles can be cleared.

According to the eighth technical feature of the present invention, it is possible to construct the sheet-like-object processing apparatus including a shredder that prevents the particles from jamming in the shredding mechanism at the time of shredding the sheet-like object, and can shred the sheet-like object into an extremely small size.

### BRIEF DESCRIPTION OF THE DRAWINGS

FIG. 1 is an explanatory view of an outline of a shredder according to an embodiment of the present invention.

FIG. 2 is an explanatory view of an overall configuration of a shredder according to a first embodiment of the present invention.

FIG. 3A is an explanatory view of a main part of the shredder according to the first embodiment, and FIG. 3B is an explanatory view of an example of a drive device for a shredding mechanism.

FIG. 4A is a detailed explanatory view of the shredding mechanism used in the first embodiment, and FIG. 4B is a detailed explanatory view of a meshing region between blade drums in a pair.

FIG. 5A is a schematic view illustrating a positional relationship between components of the shredding mechanism, FIG. 5B is an explanatory view of a main part of the blade drums in a pair, and FIG. 5C is a view illustrating a relative positional relationship in the meshing region between the blade drums in a pair.

FIG. 6 is a flowchart showing steps of a shredding control process by a control device used in the first embodiment.

FIG. 7A is a graph showing a relationship between electric current of a motor as a drive source and the number of fed sheets, FIG. 7B is an explanatory graph showing a difference in temporal change of the electric current of the motor at the time of starting driving between an initial use stage of the shredder and a sheet jam stage in the shredding mechanism, and FIG. 7C is an explanatory graph showing a difference in temporal change of the electric current of the motor after completion of the shredding between the initial use stage of the shredder and the sheet jam stage in the shredding mechanism.

FIG. 8 is a graph showing an example of operation of a cleaning mode used in the first embodiment.

FIGS. 9A and 9B are each an explanatory view of a modification of scrapers of the shredding mechanism according to the first embodiment. The scrapers in FIG. 9A are alternately arranged correspondingly to recessed portions of one of the blade drums, and the scrapers in FIG. 9B are alternately arranged correspondingly to recessed portions located between the scrapers in FIG. 9A.

FIG. 10 is an explanatory view of a main part of a shredding mechanism used in a second embodiment of the present invention.

FIG. 11 is a schematic view illustrating a positional relationship between components of the shredding mechanism used in the second embodiment.

FIG. 12A is an explanatory view of a configuration example of a first partition member of a scraper, and FIG. 12B is a detailed view of the part B in FIG. 12A.

FIG. 13A is an explanatory view of the configuration example of the first partition member of the scraper, and FIG. 13B is an explanatory view of a configuration example of a second partition member of the scraper.

FIG. 14A is a view illustrating an arrangement relationship between the blade drums and the first partition members in the shredding mechanism and, FIG. 14B is a view illustrating arrangement relationship between the blade drums and the second partition members in the shredding mechanism.

FIGS. 15A to 15C are explanatory views of an assembly process of the shredding mechanism.

FIG. 16 is an explanatory view of a main part of an image forming apparatus according to a third embodiment of the present invention.

### DETAILED DESCRIPTION OF THE PREFERRED EMBODIMENTS

### Outline of Embodiments of Present Invention

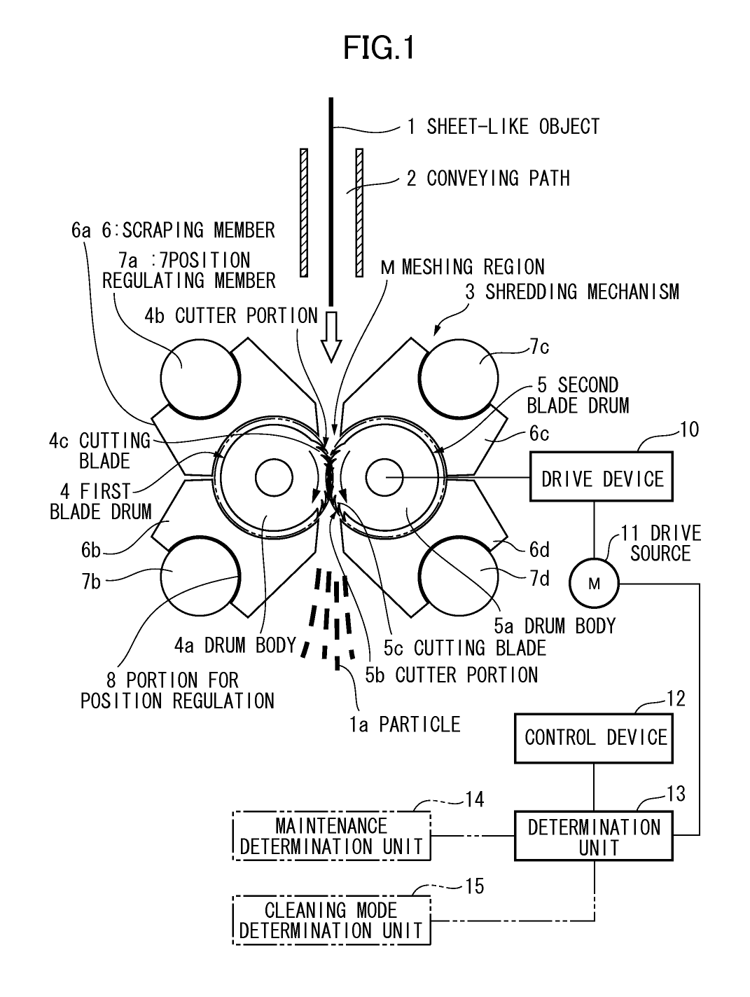

FIG. 1 illustrates an outline of a shredder according to each embodiment of the present invention.

In FIG. 1, the shredder includes: a shredding mechanism 3 for shredding a sheet-like object 1, the shredding mechanism 3 being provided in a midway of a conveying path 2 through which the sheet-like object 1 is inserted; a drive device 10 for driving the shredding mechanism 3; and a control device 12 for controlling the drive device 10. The shredding mechanism 3 includes: a first blade drum 4 including cutter portions 4b formed around a rotatable drum body 4a, the cutter portions 4b each including cutting blades 4c formed at a predetermined pitch in a rotation direction of the drum body 4a, the cutter portions 4b being integrally formed by a cutting-out process through intermediation of recessed portions (not shown) at a predetermined clearance along a direction of a rotary shaft of the drum body 4a; a second blade drum 5 configured similarly to the first blade drum 4 and so as to mesh with the first blade drum 4 in a manner that cutter portions 5b of the second blade drum 5 bite into the recessed portions of the first blade drum 4, and that the cutter portions 4b of the first blade drum 4 bite into recessed portions of the second blade drum 5; and a plurality of scraping members 6 (four scraping members 6a to 6d in this example) for scraping off particles 1a formed by shredding in a meshing region M between the first blade drum 4 and the second blade drum 5 in a pair from an inside of the recessed portions located between the cutter portions 4b of the first blade drum 4 and from an inside of the recessed portions located between the cutter portions 5b of the second blade drum 5, the plurality of scraping members 6 being arranged so as to bite into the recessed portions of the first blade drum 4 and into the recessed portions of the second blade drum 5 in a region out of the meshing region M between the first blade drum 4 and the second blade drum 5 in a pair. The control device 12 includes a determination unit 13 for determining a jam condition of the particles 1a in the shredding mechanism 3 based on a load applied to the drive device 10 during idling of the shredding mechanism 3, which is carried out by driving the drive device 10 under a state in which the sheet-like object 1 to be shredded is not conveyed into the shredding mechanism 3.

Note that, in FIG. 1, a drum body of the second blade drum 5 is denoted by the reference symbol 5a, and cutting blades of the cutter portion 5b are denoted by the reference symbol 5c.

In such technical means, the shredding mechanism 3 includes the blade drums 4 and 5 in a pair, and the scraping members 6.

Specifically, respectively in the blade drums 4 and 5 in a pair, the cutter portions 4b and 5b each including the cutting blades 4c and 5c are arrayed through intermediation of the recessed portions around the drum bodies 4a and 5a. The cutter portions 4b and 5b are extremely thin, and hence positional accuracies thereof are difficult to secure even when a plurality of cutter discs are laminated. As a countermeasure, in this example, the cutter portions 4b and 5b are integrally formed around the drum bodies 4a and 5a by a producing method of cutting out a reinforcing material such as carbon steel. In this case, it is preferred that, in order to keep sufficient cutting performance, the cutting blades 4c and 5c of the cutter portions 4b and 5b be subjected to a polishing process.

Further, with regard to the predetermined pitch at which the cutting blades 4c and 5c of the respective cutter portions 4b and 5b are formed, this pitch corresponds to a length dimension of one side of each of the rectangular particles 1a of the sheet-like object 1. Further, a clearance of each of the recessed portions between the cutter portions 4b and between the cutter portions 5b corresponds to a length dimension of another side of each of the rectangular particles 1a.

Still further, as long as the scraping members 6 are arranged so as to bite into the recessed portions between the cutter portions 4b and between the cutter portions 5b of the blade drums 4 and 5 so that an action of scraping off the particles 1a is performed, not only scraping surfaces conforming to a shape of a bottom surface of each of the recessed portions of the blade drums 4 and 5, but also projecting pieces to face part of the recessed portions may be selected as appropriate.

Yet further, the control device 12 for controlling the drive device 10 needs to include the determination unit 13 for determining the jam condition of the particles 1a in the shredding mechanism 3. When the sheet-like object 1 is shredded into such an extremely small size that the sheet-like object 1 cannot be reproduced, the particles 1a are more liable to jam around the blade drums 4 and 5 in a pair in the shredding mechanism 3 than those in a case where a shredding size is somewhat larger. As a countermeasure, in the present application, the determination unit 13 is provided so as to monitor liability of the jam of the particles 1a.

Next, description is made of typical examples or preferred examples of the shredder according to embodiments of the present invention.

First, as a typical example of the scraping members 6, the scraping members 6 may each have the scraping surface conforming to the shape of the bottom surface of each of the recessed portions of the first blade drum 4 and the recessed portions of the second blade drum 5. In this example, the scraping surface of each of the scraping members 6 is formed in conformity with the shape of the bottom surface of each of the recessed portions of the blade drums 4 and 5. Thus, the particles 1a accumulated on bottoms of the recessed portions are brought into contact with the large scraping surfaces of the scraping members 6, and scraped off by their frictional resistance.

Further, as an example of a typical position regulating structure for the scraping members 6, the scraping members 6 may be provided in a single row or in double rows so as to face the first blade drum 4 and the second blade drum 5, and regulated in position with respect to the first blade drum 4 and the second blade drum 5 by two position regulating members 7 (in this example, 7a to 7d) so that amounts of biting into the recessed portions of the blade drums 4 and 5 are regulated. Note that, in FIG. 1, portions 8 for position regulation are provided in the scraping members 6 so as to be engaged with the position regulating members 7 (provided as grooves for position regulation in the embodiments of the present invention).

In this example, when the scraping members 6 are regulated in position at two positions with respect to the blade drums 4 and 5, there is an advantage in that a relative positional relationship between the blade drums 4 and 5 and the scraping members 6 can be more accurately set than in a case where the positional regulation is performed at one position.

Further, as a preferred example of the scraping members 6, there may be provided first partition members placed so as to remove the particles 1a formed by shredding in the meshing region M between the blade drums 4 and 5 in a pair from the inside of the recessed portions of the blade drums 4 and 5, the first partition members being arranged in a plurality of stages in the region out of the meshing region M between the blade drums 4 and 5 in a pair so as to cover peripheries of the recessed portions of the blade drums 4 and 5. In addition, there may be provided second partition members placed so as to close gaps through which the particles 1a formed by shredding in the meshing region M between the blade drums 4 and 5 in a pair enter between the first partition members, the second partition members being arranged in a plurality of stages in the region out of the meshing region M between the blade drums 4 and 5 in a pair so as to cover peripheries of the cutter portions 4b and 5b of the blade drums 4 and 5.

In this example, the first partition members may be formed into any shape as long as the recessed portions of the blade drums 4 and 5 are surrounded and the particles 1a in the inside of the recessed portions are removed.

Further, the second partition members may be formed into any shape as long as the cutter portions 4b and 5b of the blade drums 4 and 5 are surrounded and the gaps through which the particles 1a enter between the first partition members are closed.

Note that, in order to reduce the shredding size, the clearance of each of the cutter portions 4b and 5b and the recessed portions is reduced. Thus, the first partition members and the second partition members are inevitably thinned. For this reason, it is preferred that those partition members be formed into a plate-like shape so that a surface rigidity is secured.

In this example, the scraping members 6 are appropriately designed to prevent the particles 1a from accumulating around the shredding mechanism 3, and hence shredding performance of the shredding mechanism 3 can be maintained. For this reason, an oil supply system may be employed to maintain the shredding performance of the shredding mechanism 3, but there is substantially no need to perform oil supply.

Next, as a typical example of the determination unit 13, the drive device 10 may include a drive source 11 for driving the blade drums 4 and 5 in a pair in the shredding mechanism 3, and the determination unit 13 of the control device 12 may be configured to grasp a load applied to the drive device 10 by detecting drive current of the drive source 11.

In this example, in a situation where the particles 1a jam in the shredding mechanism 3 to some extent, even when the sheet-like object 1 is not shredded, variation of the drive current of the drive source 11 is utilized. The variation of the drive current of the drive source 11 is detected in response to a load generated in the drive source 11 under a jam condition of the particles 1a.

Further, in this embodiment, as a preferred example of the control device 12, the control device 12 may include a maintenance determination unit 14 for determining, based on results of determination by the determination unit 13, whether or not the jam condition of the particles 1a in the shredding mechanism 3 necessitates maintenance of the shredding mechanism 3.

This maintenance determination unit 14 may be of any type as long as users of the shredder can determine whether or not the maintenance is needed. In this case, as appropriate, a message indicating the need for maintenance may be displayed on a display. Alternatively, in consideration of the precise configuration of the shredding mechanism 3, by making, for example, a maintenance service contract, a maintenance requesting process may be executed via communication as needed.

Further, it is preferred that, in consideration of a life of the shredding mechanism 3, settings be made in advance so that operations to stop and restart the shredder cannot be easily performed by users in a case where the maintenance determination unit 14 determines that the maintenance is needed.

Still further, as another preferred example of the control device 12, the drive source 11 of the drive device 10 may be configured to rotate the blade drums 4 and 5 in a pair in the shredding mechanism 3 forward and reversely, and the control device 12 may include a cleaning mode determination unit 15 for determining, based on results of determination by the determination unit 13, whether or not the jam condition of the particles 1a in the shredding mechanism 3 necessitates execution of a cleaning mode for the shredding mechanism 3. The control device 12 may execute a cleaning process involving at least one reverse rotation of the drive source 11 in a case where the cleaning mode needs to be executed.

Also in a case where the jam condition of the particles 1a in the shredding mechanism 3 can be cleared by a user, the cleaning mode determination unit 15 may determine whether or not the maintenance mode needs to be executed, and execute a predetermined cleaning process when the cleaning mode needs to be executed.

The cleaning process is only required to include at least one reverse rotation of the drive source 11. When the reverse rotation of the drive source 11 is performed in this way, the blade drums 4 and 5 in a pair are rotated in a reverse rotation direction, and thus the particles 1a jamming in a forward rotation direction are moved back in the reverse rotation direction, thereby being more easily removed. In this way, the particles 1a are cleaned off.

Note that, the cleaning process in this example is only required to include at least one reverse rotation of the drive source 11 is performed. When the cleaning operation is insufficient, as appropriate, a forward rotation may be additionally performed, or forward/reverse rotations may be performed once or a plurality of times.

As a matter of course, the shredder described above may be independently used. However, the present application is not limited thereto, and includes a sheet-like-object processing apparatus in which this shredder is installed.

As an example of sheet-like-object processing apparatus of this type, there may be provided a sheet-like-object processing apparatus including a processing unit (not shown) for processing the sheet-like object 1, and the shredder configured to shred the sheet-like object 1 in a case where a process by this processing unit has failed to be properly executed on the sheet-like object 1. Examples of this processing unit may include functional portions of any type as long as the sheet-like object 1 may be processed. Specifically, in a case where the sheet-like object 1 is a recording material such as a sheet, an image forming unit for forming images, or a post-processing unit for executing, for example, a folding process on the recording material serves as the processing unit.

Now, description is made of embodiments of the present invention in more detail with reference to the accompanying drawings.

### First Embodiment

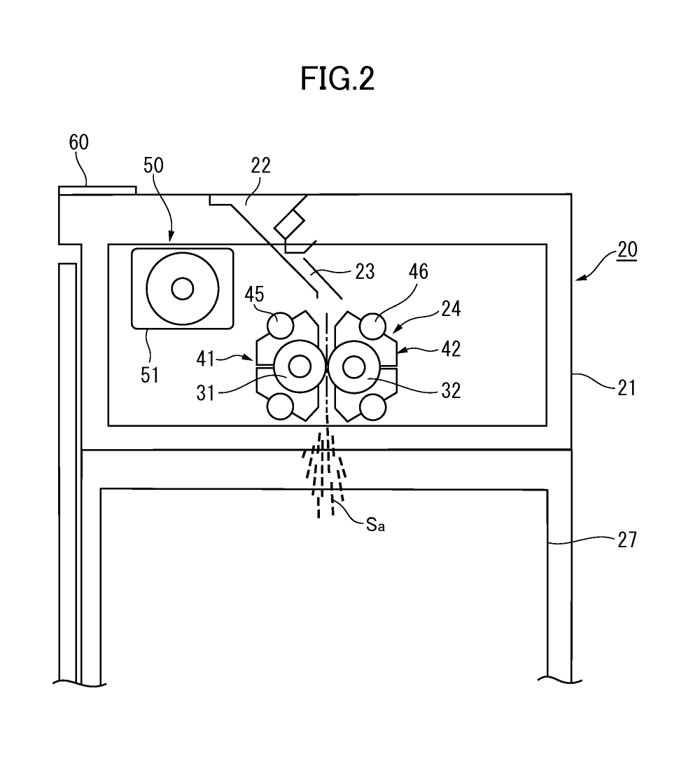

FIG. 2 illustrates an overall configuration of a shredder according to a first embodiment of the present invention.

—Overall Configuration of Shredder—

As illustrated in FIG. 2, a shredder 20 includes a shredder casing 21 having a substantially rectangular parallelepiped shape. A feed port 22 through which sheets as sheet-like objects to be shredded are fed is opened in an upper surface of the shredder casing 21. A conveying path 23 defined by a pair of guide chutes is provided in the feed port 22. A shredding mechanism 24 is arranged in a midway of the conveying path 23. Below the shredding mechanism 24 in the shredder casing 21, a trash container 27 for receiving particles of the sheets is arranged so as to be removable.

Specifically, the shredding mechanism 24 employs a cross-cut type using blade drums 31 and 32 in a pair as cutter elements. With this, when the sheets are inserted through a meshing region between the blade drums 31 and 32 in a pair, the sheets are shredded simultaneously in a direction along a conveying direction of the sheets (longitudinal direction) and a crossing direction substantially orthogonal thereto (lateral direction). Note that, in FIG. 2, a drive device for driving the shredding mechanism 24 is denoted by the reference symbol 50, and an operation panel for operating the shredder 20 is denoted by the reference symbol 60.

—Shredding Mechanism—

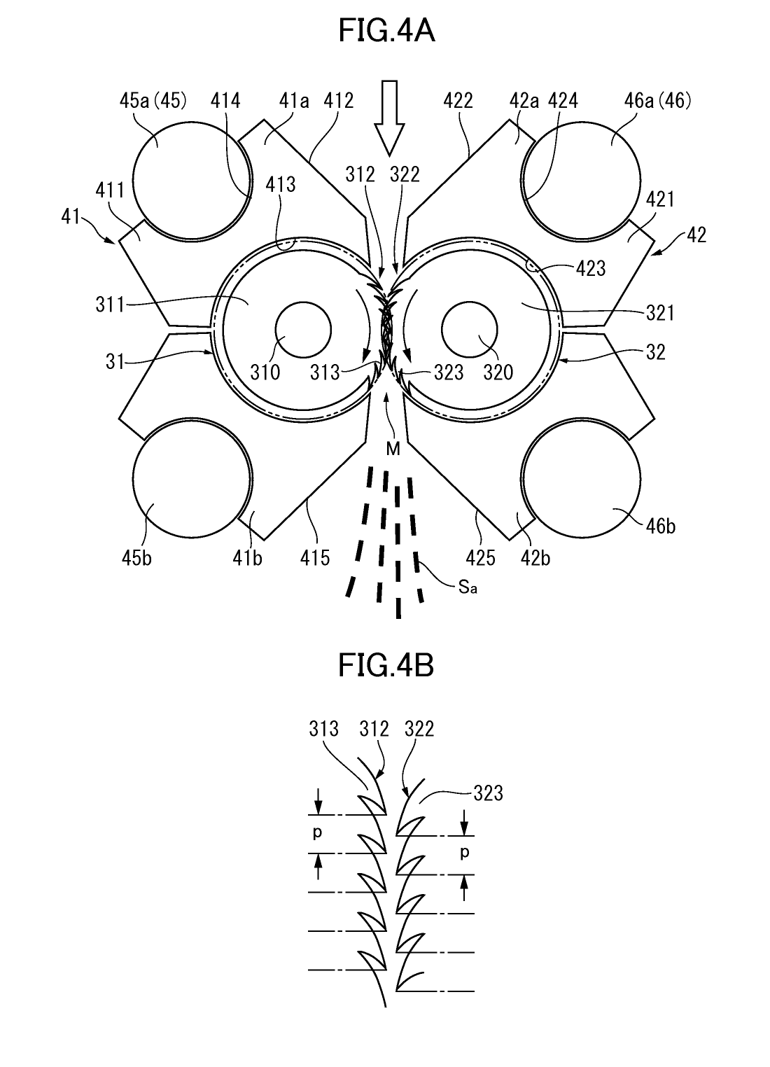

In this embodiment, as illustrated in FIGS. 2, 4A and 4B, and 5A to 5C, the first blade drum 31 includes a drum body 311 made of a high strength material such as carbon steel, and the drum body 311 is supported by a support frame (not shown) in a rotatable manner about a rotary shaft 310.

In addition, on a peripheral surface of the drum body 311, cutter portions 312 each including cutting blades 313 formed at a predetermined pitch p (for example, 3.5 mm) in a rotation direction of the drum body 311 are integrally formed by a cutting-out process through intermediation of recessed portions 315 at a predetermined clearance g (for example, 0.7 mm) along a direction of the rotary shaft 310 of the drum body 311. Note that, a bottom surface of each of the recessed portions 315 between the cutter portions 312 is formed as a spacer portion 314 having a circular section, and a width dimension of a distal edge portion of each of the cutter portions 312 is set to be equivalent to that of the recessed portions 315.

In this embodiment, the cutting blades 313 have distal edge portions as a functional portion for cutting the sheets in a direction intersecting with the conveying direction of the sheets (lateral direction), and lateral edge portions, which are located on both sides of each of the distal edge portions, as another functional portion for cutting the sheets in the direction along the conveying direction of the sheets (longitudinal direction). In addition, in order to keep sufficient cutting performance, the distal edge portions and the lateral edge portions of the cutting blades 313 are subjected to a polishing process.

Further, as illustrated in FIGS. 2, 4A and 4B, and 5A to 5C, the second blade drum 32 is constructed substantially similarly to the first blade drum 31 with a high strength material such as carbon steel. On a peripheral surface of a drum body 321, cutter portions 322 each including cutting blades 323 are integrally formed by the cutting-out process through intermediation of recessed portions 325. Note that, a rotary shaft of the drum body 321 is denoted by the reference symbol 320, and a circular-section spacer portion formed of a bottom surface of each of the recessed portions 325 between the cutter portions 322 is denoted by the reference symbol 324.

Still further, the second blade drum 32 meshes with the first blade drum 31 in a manner that the cutter portions 322 bite into the recessed portions 315 of the first blade drum 31, and that the cutter portions 312 of the first blade drum 31 bite into the recessed portions 325.

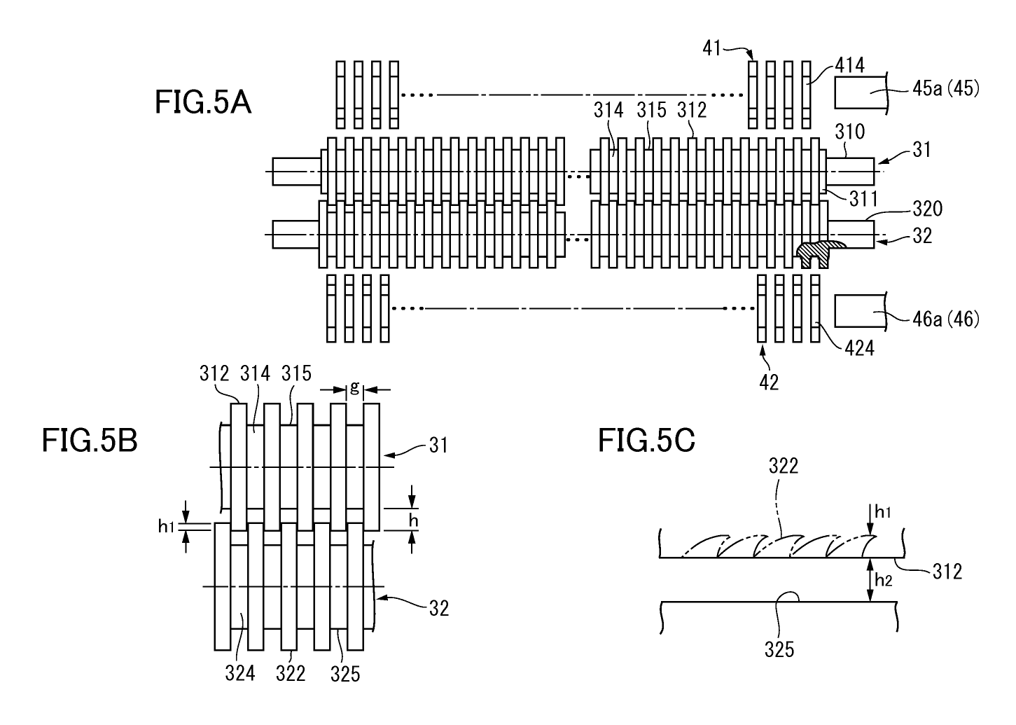

Yet further, in a meshing region M between the blade drums 31 and 32 in a pair, as illustrated in FIGS. 5A to 5C, when the recessed portions 315 (or 325) have a depth “h”, the cutting blades 323 (or 313) of the cutter portions 322 (or 312) bite into the recessed portions 315 (or 325) with a dimension h1 by which the cutting blades 323 (or 313) are received in the recessed portions 315 (or 325). Note that, in FIG. 5C, a dimension obtained by subtracting the bite-in dimension h1 of the cutting blades 323 (or 313) from the depth h of the recessed portions 315 (or 325) is denoted by the reference symbol h2.

In addition, in this embodiment, as illustrated in FIGS. 2, 4A and 4B, and 5A to 5C, scrapers 41 and 42 as scraping members are provided in a region out of the meshing region M between the blade drums 31 and 32 in a pair. Those scrapers 41 and 42 are each formed of a plate member made of a high strength material such as carbon steel.

In this embodiment, in the region out of the meshing region M between the blade drums 31 and 32 in a pair, in each of the scrapers 41, upper scrapers 41a that surround upper half of the first blade drum 31 and lower scrapers 41b that surround lower half of the first blade drum 31 are provided separately from each other.

Those scrapers 41 (41a and 41b) are arranged so as to bite into the recessed portions 315 located between the cutter portions 312 of the first blade drum 31 so as to scrape off particles Sa formed in the meshing region M between the blade drums 31 and 32 in a pair from an inside of the recessed portions 315.

On the other hand, in the region out of the meshing region M between the blade drums 31 and 32 in a pair, in each of the scrapers 42, upper scrapers 42a that surround upper half of the second blade drum 32 and lower scrapers 42b that surround lower half of the second blade drum 32 are provided separately from each other.

Similarly to the scrapers 41 (41a and 41b) on one side, those scrapers 42 (42a and 42b) are arranged so as to bite into the recessed portions 325 located between the cutter portions 322 of the second blade drum 32 so as to scrape off the particles Sa formed in the meshing region M between the blade drums 31 and 32 in a pair from an inside of the recessed portions 325.

Further, in each of the upper scrapers 41a (or 42a), a guide surface 412 (or 422) for guiding the sheets into the meshing region M between the blade drums 31 and 32 in a pair is formed on a sheet conveying side of a plate-like scraper body 411 (or 421). Still further, a scraping surface 413 (or 423) conforming to a shape of the bottom surface of each of the recessed portions 315 (or 325) is formed at a part facing corresponding one of the recessed portions 315 (or 325) of the blade drum 31 (or 32). Yet further, a substantially semicircular groove 414 (or 424) for position regulation is formed at a part facing a position regulating roller 45 (or 46) described later.

On the other hand, in each of the lower scrapers 41b (or 42b), similarly to the upper scrapers 41a (or 42a), the scraping surface 413 (or 423) and the groove 414 (or 424) for position regulation are formed. Further, a guide surface 415 (or 425) for guiding downward the particles Sa formed by shredding in the meshing region M between the blade drums 31 and 32 in a pair is formed on a sheet discharge side of the plate-like scraper body 411 (or 421).

Further, in this embodiment, as illustrated in FIGS. 2, 4A and 4B, and 5A to 5C, the scrapers 41 and 42 are provided around the blade drums 31 and 32. After the blade drums 31 and 32 are assembled to predetermined assembly positions, the scrapers 41 and 42 are arranged so as to bite into the recessed portions 315 and 325 of the blade drums 31 and 32. In this state, the position regulating rollers 45 (in this embodiment, 45a and 45b) and 46 (in this embodiment, 46a and 46b) are fitted into the grooves 414 and 424 for position regulation of the scrapers 41 (41a and 41b) and 42 (42a and 42b). At this time, when the position regulating rollers 45 and 46 are positioned to predetermined positions, with reference to those positions of the position regulating rollers 45 and 46, the scrapers 41 and 42 are regulated in position with respect to the blade drums 31 and 32. As a result, the scraping surfaces 413 and 423 of the scrapers 41 and 42 are arranged at predetermined regulated positions with respect to the bottom surfaces of the recessed portions 315 and 325 of the blade drums 31 and 32.

—Drive Device—

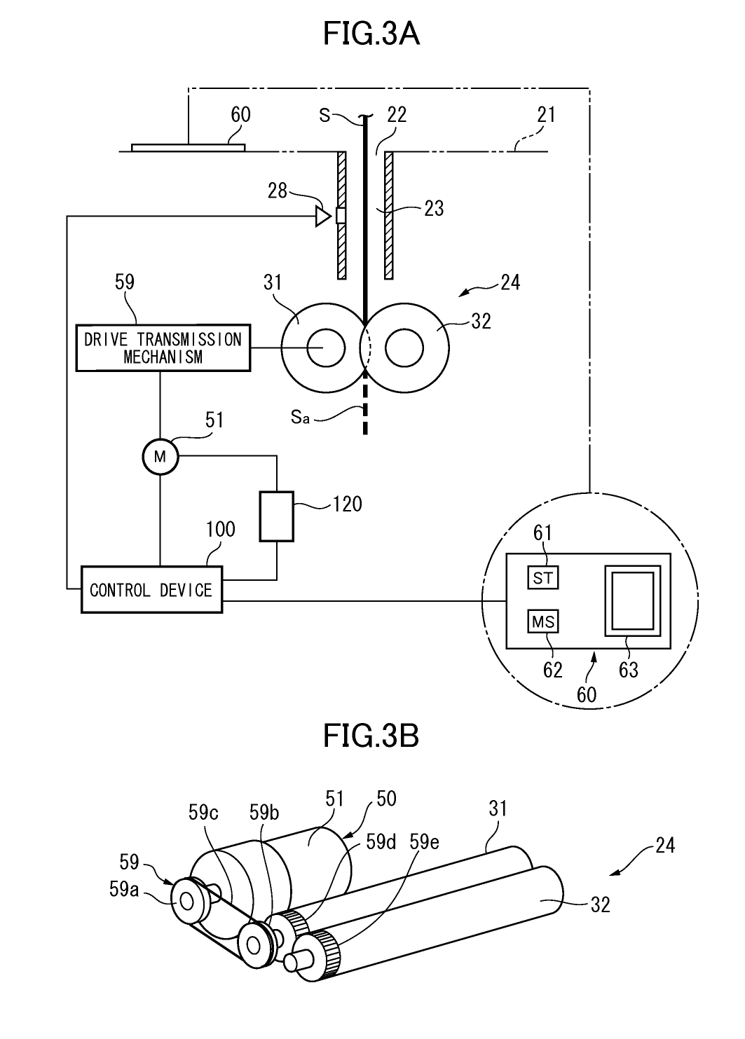

In this embodiment, as illustrated in FIG. 2 and FIGS. 3A and 3B, the drive device 50 includes a drive motor 51 as a drive source, and a drive transmission mechanism 59 for transmitting a driving force from the drive motor 51 to the blade drums 31 and 32 in a pair of the shredding mechanism 24.

In this embodiment, the drive transmission mechanism 59 includes pulleys 59a and 59b fixed respectively to a drive shaft of the drive motor 51 and the rotary shaft 310 of the first blade drum 31, and a transmission belt 59c looped around the pulleys 59a and 59b. Further, transmission gears 59d and 59e are engaged with each other and fixed to the rotary shafts of the blade drums 31 and 32 in a pair.

—Control Device—

Further, in this embodiment, as illustrated in FIG. 3A, the drive device 50 for driving the shredding mechanism 24 is controlled by a control device 100.

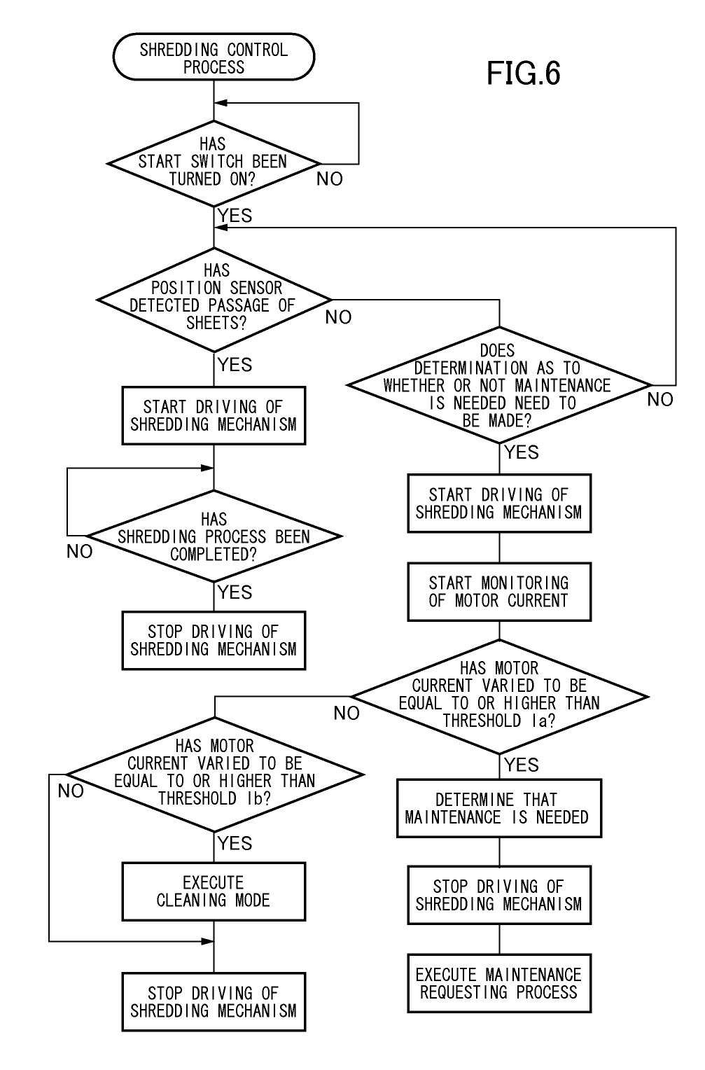

In this embodiment, the control device 100 has a microcomputer system including a CPU, a RAM, a ROM, and input/output ports. The control device 100 receives, for example, operation signals from the operation panel 60, and signals from a position sensor 28 for detecting whether or not sheets S are conveyed in the conveying path 23 via the input/output ports. The control device 100 causes the CPU and the RAM to execute a shredding control program (refer to FIG. 6) preinstalled in the ROM, to thereby transmit predetermined control signals to the drive device 50 for the shredding mechanism 24 via the input/output ports.

In addition, a current detector 120 is provided for the drive motor 51 so as to detect drive current supplied to the drive motor 51.

Note that, in this embodiment, as illustrated in FIG. 3A, the operation panel 60 includes a start switch 61 (abbreviated as “ST” in FIG. 3A) for turning on the shredder 20, a mode selection switch 62 (abbreviated as “MS” in FIG. 3A) for performing ON operations to specify, for example, a discharge mode for reversely discharging the sheets S in a case where the sheets S jam in the conveying path 23, and a cleaning mode for executing a cleaning process in a case where the particles Sa jam in the shredding mechanism 24, and a display 63 for displaying operating conditions of the shredder 20. Further, as the position sensor 28, sensors of a mechanical type, an optical type, and other types may be selected as appropriate as long as passage of the sheets S can be detected.

—Shredding Control Process of Shredder—

Next, description is made of a shredding control process of the shredder according to this embodiment mainly with reference to FIG. 3A and the flowchart shown in FIG. 6.

<Normal Shredding Process>

First, when the control device 100 determines that the ON operation has been input via the start switch 61 of the operation panel 60, the control device 100 specifies a predetermined one of driving conditions of the drive device 50 (such as a driving speed condition of the drive motor 51).

In this state, the sheets S, which are fed into the feed port 22 of the shredder casing 21, are moved to the shredding mechanism 24 along the conveying path 23. At this time, when the position sensor 28 detects the passage of the sheets S, the signal detected by the position sensor 28 is transmitted to the control device 100. In response thereto, the drive motor 51 drives the blade drums 31 and 32 in a pair in the shredding mechanism 24 in accordance with the predetermined one of the driving conditions.

In this embodiment, the sheets S are shredded simultaneously in the longitudinal and lateral directions by passing through the meshing region M between the blade drums 31 and 32 in a pair. The particles Sa formed through the shredding are scraped off from the blade drums 31 and 32 by the scrapers 41 and 42, and fall downward.

In such a shredding process, the particles Sa are formed by shredding into an extremely small size of 0.7 mm×3.5 mm (2.45 mm²), for example. Thus, even when attempts are made to reproduce information of the original sheet by collecting the particles Sa after the shredding process, the reproduction is nearly impossible because the shredding size of the particles Sa is small.

Then, when a predetermined time period elapses after a trailing end of the sheets S passes by the position sensor 28 (time period in which completion of the shredding process is presumed), the control device 100 determines the shredding process has been completed, and stops driving of the drive motor 51. With this, a series of the shredding control process is completed.

<Maintenance Determination Process>

In this embodiment, as described above, the shredding size of the particles Sa is extremely small, and hence the particles Sa tend to be accumulated around the blade drums 31 and 32 in a pair.

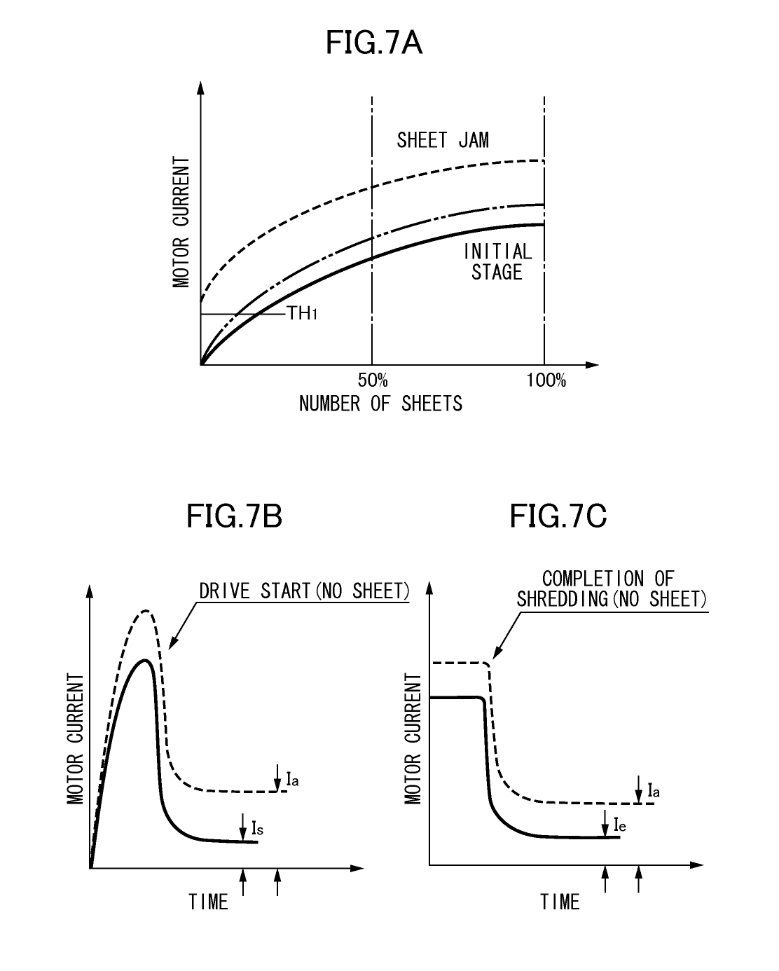

Specifically, as shown in FIG. 7A, in an initial stage of start of use of the shredder, the drive current of the drive motor 51, which is substantially zero under a state in which there are no sheets S to be fed into the feed port 22 of the shredder casing 21, varies to gradually increase in accordance with an increase in the number of the sheets S (number of the sheets S to be simultaneously conveyed into the feed port 22).

On the other hand, as a result of use of the shredder over time, for example, in a case where the particles Sa accumulated around the blade drums 31 and 32 in a pair cause a sheet jam, even when there are no sheets S to be fed into the feed port 22 of the shredder casing 21, the drive current of the drive motor 51 reaches a predetermined level higher than a preset threshold TH₁, and varies to further increase in accordance with an increase in the number of the sheets S. This is presumably because a load is applied to the drive motor 51 due to a jam of the particles Sa around the blade drums 31 and 32 in a pair.

In such a situation, when the drive motor 51 is driven under a state in which an excessive load is applied to the drive motor 51, the shredding mechanism 24 may be damaged.

As a countermeasure, in this embodiment, as shown in FIG. 6, whether or not maintenance of the shredder is needed is determined at preset timings (timing of actuation of the shredder, timing of completion of shredding by the shredder, or timing that is manually specified via the mode selection switch 62) under a condition in which no sheets S are fed in the feed port 22 of the shredder casing 21.

In order to determine whether or not the maintenance is needed, first, the drive motor 51 starts to be driven so that monitoring of the drive current of the motor is started. At this time, whether or not the current of the drive motor 51 has varied to be equal to or higher than a preset threshold level Ia is determined. In this embodiment, this threshold level Ia is set to a level at which the load applied to the drive motor 51 due to an excessive jam of the particles Sa in the shredding mechanism 24 is so high that the maintenance is needed.

In this state, for example, at the timing of actuation of the shredder, as shown in FIG. 7B, the drive current of the drive motor 51 varies to reach a peak once immediately after the actuation, and then decrease to be maintained at a stable level. However, in a case where the drive current in the stable range exceeds an allowable level Is and reaches the threshold level Ia or higher, excessive accumulation of the particles Sa in the shredding mechanism 24 is grasped. Alternatively, for example, at the timing of completion of shredding, as shown in FIG. 7C, the drive current of the drive motor 51 varies to decrease after the completion of shredding, and then be maintained at a stable level. However, in a case where the drive current in the stable range exceeds an allowable level Ie and reaches the threshold level Ia or higher, excessive accumulation of the particles Sa in the shredding mechanism 24 is grasped.

In this way, when the drive current of the drive motor 51 reaches the threshold level Ia or higher, the control device 100 determines that the maintenance is needed, and stops driving of the shredding mechanism 24. With this, a maintenance requesting process is executed.

As an example of the maintenance requesting process, a message such as “Maintenance Required” may be displayed on the display 63 so as to prompt a user to request maintenance. Alternatively, in a case where a shredder with a communication function is used, the communication function may be used for notification of the maintenance requesting process to a maintenance engineer.

<Cleaning Mode>

Further, in this embodiment, with regard to determination as to whether or not the maintenance is needed, the amount of the particles Sa accumulated in the shredding mechanism 24 may be small, and the maintenance may not need to be performed. In such a case, when the small amount of the particles Sa is left as it is, the maintenance needs to be performed sooner or later. In this embodiment, a cleaning mode of executing a process of cleaning the particles Sa accumulated in the shredding mechanism 24 is executed.

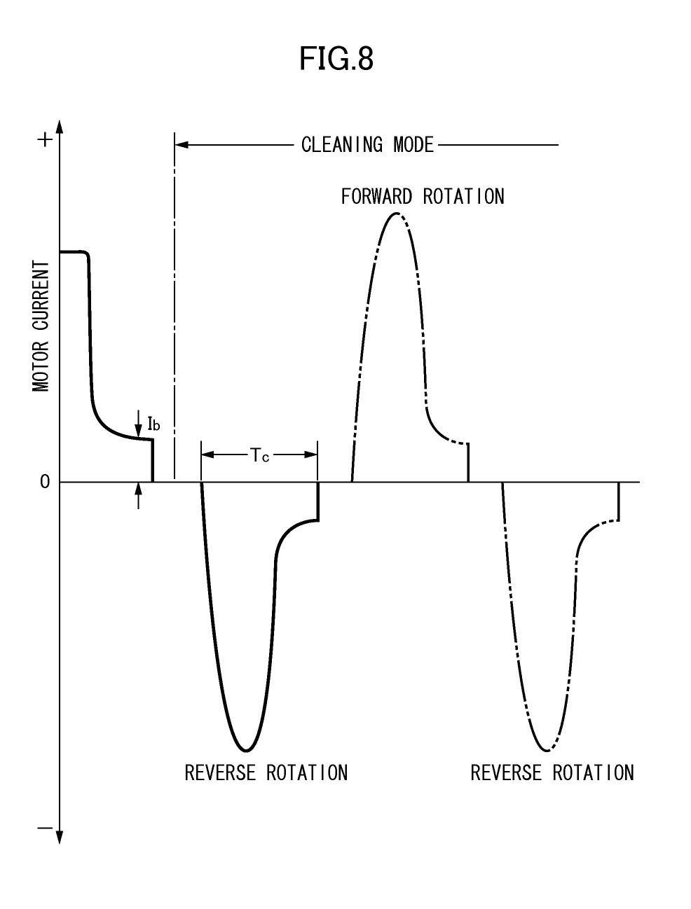

Specifically, as shown in FIG. 8, in a case where the drive current of the drive motor 51, which varies to decrease at the timing of, for example, completion of shredding, and then be maintained at a stable level, reaches thereafter at least a threshold level Ib that is higher than the allowable level Ie (refer to FIG. 7C) and lower than the threshold level Ia, slight accumulation of the particles Sa in the shredding mechanism 24 is grasped.

In this case, the control device 100 executes the cleaning mode. This cleaning mode includes performing reverse rotation of the drive motor 51 after the completion of shredding as shown in FIG. 8, and then, repeating forward rotation and reverse rotation by a predetermined number of times as appropriate as indicated by the imaginary lines in FIG. 8.

In this way, forward/reverse rotations of the drive motor 51 are repeated to perform forward/reverse rotations of the blade drums 31 and 32 in a pair. With this, the particles Sa accumulated around the blade drums 31 and 32 can be effectively scraped off. In this way, the particles Sa accumulated in the shredding mechanism 24 can be cleaned.

Note that, in the cleaning mode of this embodiment, the forward/reverse rotations of the drive motor 51 are repeated several times, however, an effect of the cleaning can be obtained to some extent as long as the reverse rotation of the drive motor 51 is performed at least once.

Modification

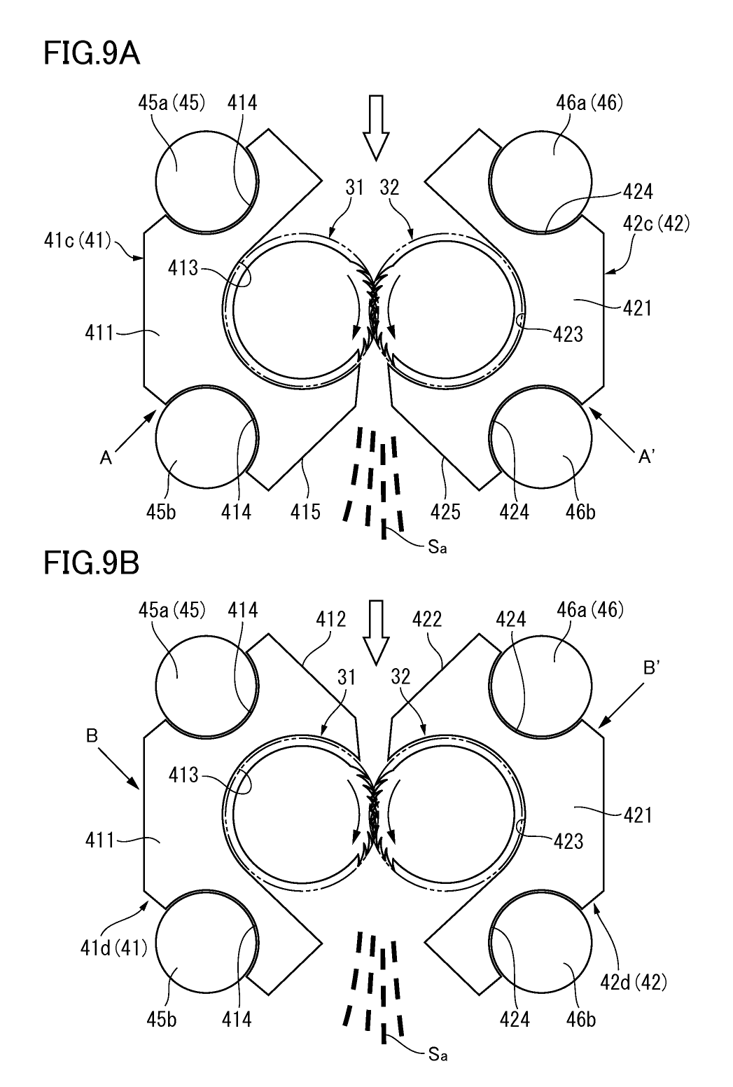

In this embodiment, the scrapers 41 and 42 are provided separately on upper and lower sides around the blade drums 31 and 32. However, the present invention is not necessarily limited thereto. For example, as illustrated in FIGS. 9A and 9B, scrapers 41 (specifically, 41c and 41d) and 42 (specifically, 42c and 42d) that are not separated to the upper and lower sides around the blade drums 31 and 32 may be used.

In this modification, as illustrated in FIG. 9A, the scraper bodies 411 and 421 of the scrapers 41c and 42c have, for example, the scraping surfaces 413 and 423 that are cut out in a substantially U-shape, the grooves 414 and 424 for position regulation, and the guide surfaces 415 and 425 for discharging the particles Sa. The scrapers 41c and 42c are arranged so as to be capable of being inserted in directions of the arrows A and A′ and alternately meshing with the recessed portions (not shown) of the blade drums 31 and 32.

Further, as illustrated in FIG. 9B, the scraper bodies 411 and 421 of the scrapers 41d and 42d have, for example, the guide surfaces 412 and 422 for guiding the sheets S, the scraping surfaces 413 and 423 that are cut out in a substantially U-shape, and the grooves 414 and 424 for position regulation. The scrapers 41d and 42d are arranged, adjacently to the scrapers 41c and 42c, to be capable of being inserted in directions of the arrows B and B′ and alternately meshing with the recessed portions (not shown) of the blade drums 31 and 32.

In this modification, the scrapers 41c and 42c do not have the guide surfaces for guiding the sheets S, and the scrapers 41d and 42d do not have the guide surfaces for guiding the particles Sa in a discharge direction. However, functions of those guide surfaces are alternately exerted by the scrapers 41 (41c and 41d) and 42 (42c and 42d), and hence functions to guide the sheets S and the particles Sa are reliably secured.

### Second Embodiment

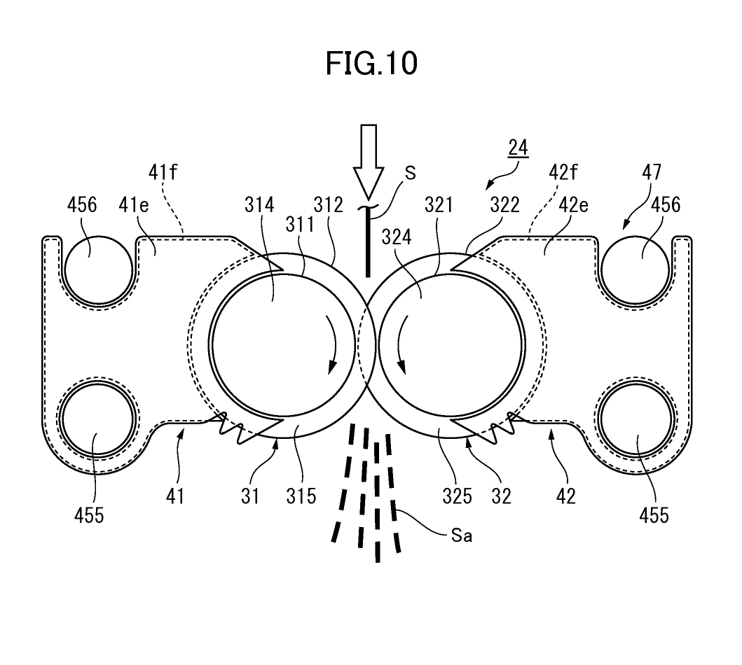

FIG. 10 illustrates a main part of the shredding mechanism 24 of the shredder according to a second embodiment of the present invention.

In the shredding mechanism 24 according to this embodiment, the blade drums 31 and 32 in a pair are substantially the same as those in the first embodiment, but the scrapers 41 and 42 as scraping members are different from those in the first embodiment.

In this embodiment, the scrapers 41 include first partition members 41e provided so as to surround substantially left half of the first blade drum 31, that is, surround an opposite side of the meshing region M between the blade drums 31 and 32 in a pair, and provided correspondingly to the recessed portions 315 between the cutter portions 312 of the first blade drum 31, and second partition members 41f arranged between the first partition members 41e correspondingly to the cutter portions 312 of the first blade drum 31.

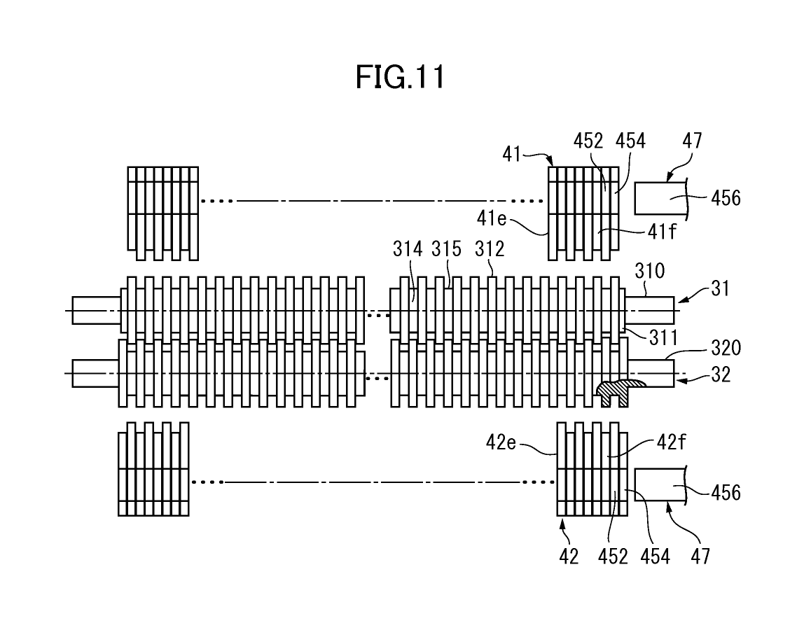

Note that, as illustrated in FIGS. 10 and 11, the first partition members 41e are arranged so as to bite into the recessed portions 315 between the cutter portions 312 of the first blade drum 31. With this, among the particles Sa formed by shredding in the meshing region M between the blade drums 31 and 32 in a pair, particles Sa accumulated in the recessed portions 315 are scraped off.

Further, as illustrated in FIGS. 10 and 11, the second partition members 41f are arranged so as to surround the cutter portions 312 of the first blade drum 31. With this, among the particles Sa formed by shredding in the meshing region M between the blade drums 31 and 32 in a pair, particles Sa adhering to peripheries of the cutter portions 312 are scraped off.

On the other hand, the scrapers 42 include first partition members 42e provided so as to surround substantially right half of the second blade drum 32, that is, surround an opposite side of the meshing region M between the blade drums 31 and 32 in a pair, and provided correspondingly to the recessed portions 325 between the cutter portions 322 of the second blade drum 32, and second partition members 42f arranged between the first partition members 42e correspondingly to the cutter portions 322 of the second blade drum 32.

Note that, as illustrated in FIGS. 10 and 11, the first partition members 42e are arranged so as to bite into the recessed portions 325 between the cutter portions 322 of the second blade drum 32. With this, among the particles Sa formed by shredding in the meshing region M between the blade drums 31 and 32 in a pair, particles Sa accumulated in the recessed portions 325 are scraped off.

Further, as illustrated in FIGS. 10 and 11, the second partition members 42f are arranged so as to surround the cutter portions 322 of the second blade drum 32. With this, among the particles Sa formed by shredding in the meshing region M between the blade drums 31 and 32 in a pair, particles Sa adhering to peripheries of the cutter portions 322 are scraped off.

<Configuration Example of First Partition Members>

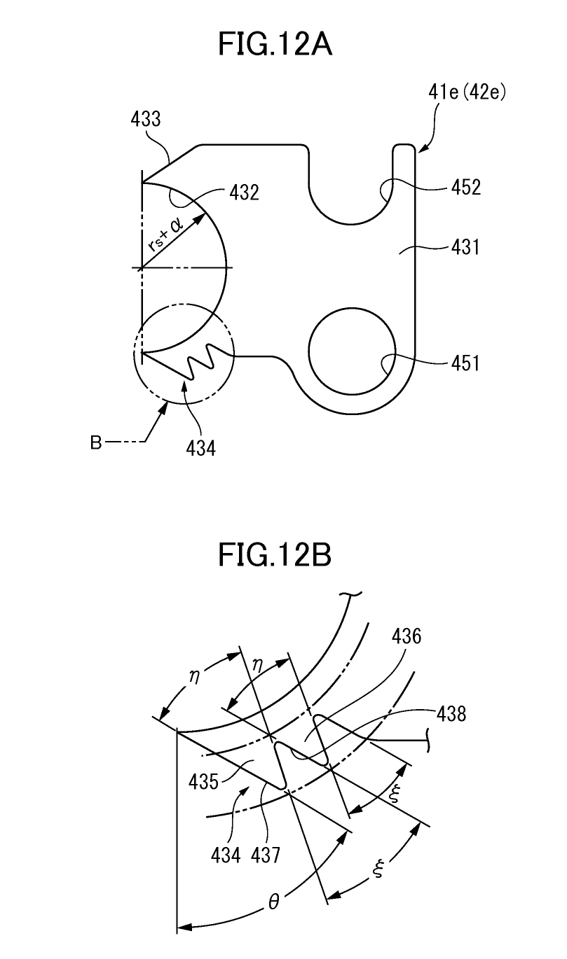

As illustrated in FIG. 10 and FIGS. 12A and 12B, the first partition members 41e (or 42e) each include a plate-like partition body 431, and have a circular-arc edge surface (in this example, semicircular edge surface) 432 conforming to a shape of a bottom surface of, the recessed portion 315 (or 325) of the blade drum 31 (or 32) at a part of the partition body 431 facing the recessed portion 315 (or 325). Further, a guide surface 433 for guiding the sheets S into the meshing region M between the blade drums 31 and 32 in a pair is formed on one side of the partition body 431, in which the sheets S are conveyed. In addition, a guide piece 434 for guiding downward the particles Sa formed by shredding in the meshing region M between the blade drums 31 and 32 in a pair is formed on another side of the partition body 431, on which the sheets S are discharged.

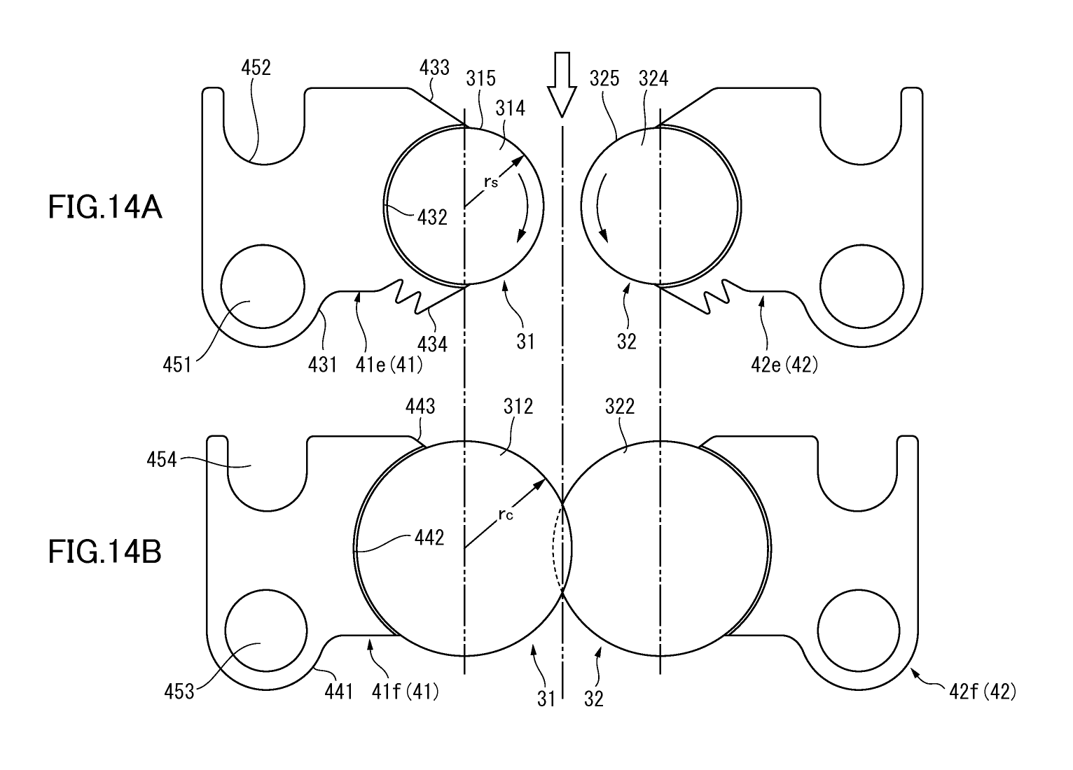

In this example, as illustrated in FIGS. 12A and 14A, the edge surface 432 of the first partition member 41e (or 42e) is formed into a circular-arc surface having a radius of rs+α, which is slightly larger than a radius rs of the spacer portion 314 (or 324) located between the cutter portions 312 (or 322) of the blade drum 31 (or 32).

Further, in this example, as illustrated in FIGS. 12A and 12B, the guide piece 434 includes two mountain-shaped guide projections 435 and 436 extending obliquely downward. The guide projection 435 located on a side of a path of the sheets S is formed, for example, to have an inclined surface 437 inclined at a predetermined angle θ (for example, 30° to 50°) with respect to a vertical direction, and to have a distal end corner portion projecting at an angle η (for example, 20° to 40°: η<θ in this example). Further, the another guide projection 436 is formed, for example, to be adjacent to the guide projection 435 through intermediation of a V-groove 438 having a distal end angle (for example, 20° to 40°, η=ξ in this example), and to project at a distal end angle η.

<Configuration Example of Second Partition Members>

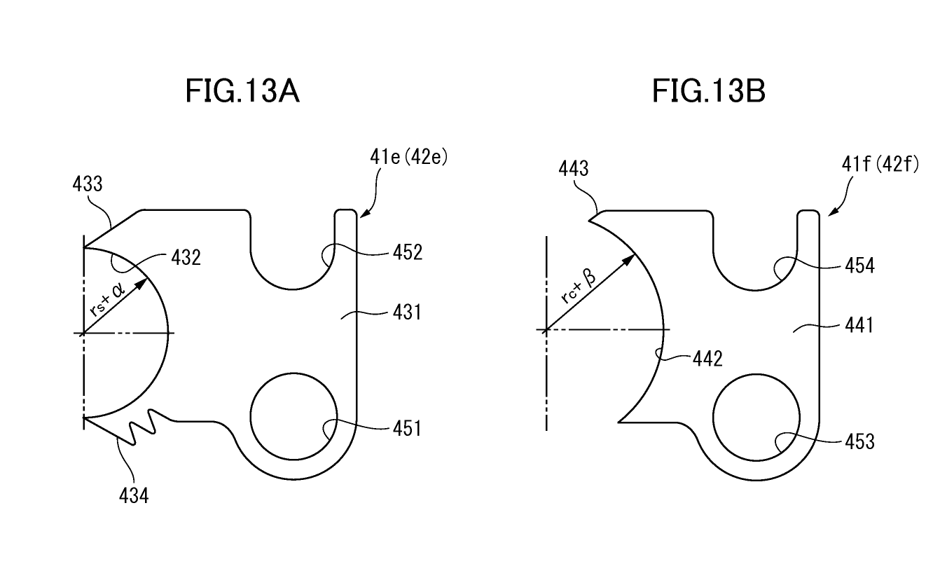

As illustrated in FIG. 10 and FIGS. 13A and 13B, the second partition members 41f (or 42f) each include a plate-like partition body 441, and have a circular-arc edge surface (in this example, an angle of the circular arc is less than that of a semicircular, an edge surface of 140° to 150°, for example) 442 conforming to distal end outer rims of the cutter portions 312 (or 332) of the blade drum 31 (or 32) at a part of the partition body 441.

In this example, as illustrated in FIGS. 13B and 14B, the edge surface 442 of the second partition member 41f (or 42f) is formed into a circular-arc surface having a radius of rc+β, which is slightly larger than a radius rc of the distal end outer rims of the cutter portions 312 (or 322) of the blade drum 31 (or 32).

Then, in this example, the second partition members 41f (or 42f) are each formed so as to have a guide surface 443 following the guide surfaces 433 of the first partition members 41e (or 42e) at the time when the second partition members 41f (or 42f) are overlapped with the first partition members 41e (or 42e), and to have an upper side portion, a lower side portion, and a lateral side portion that is located on an opposite side of the edge surface 432, which substantially match with those of the partition body 431 of the first partition members 41e (or 42e).

<Positioning Mechanism>

In this embodiment, as illustrated in FIGS. 10 to 14B, the shredding mechanism. 24 includes a positioning mechanism 47 capable of positioning the first partition members 41e (or 42e) and the second partition members 41f (or 42f) of the scrapers 41 (or 42).

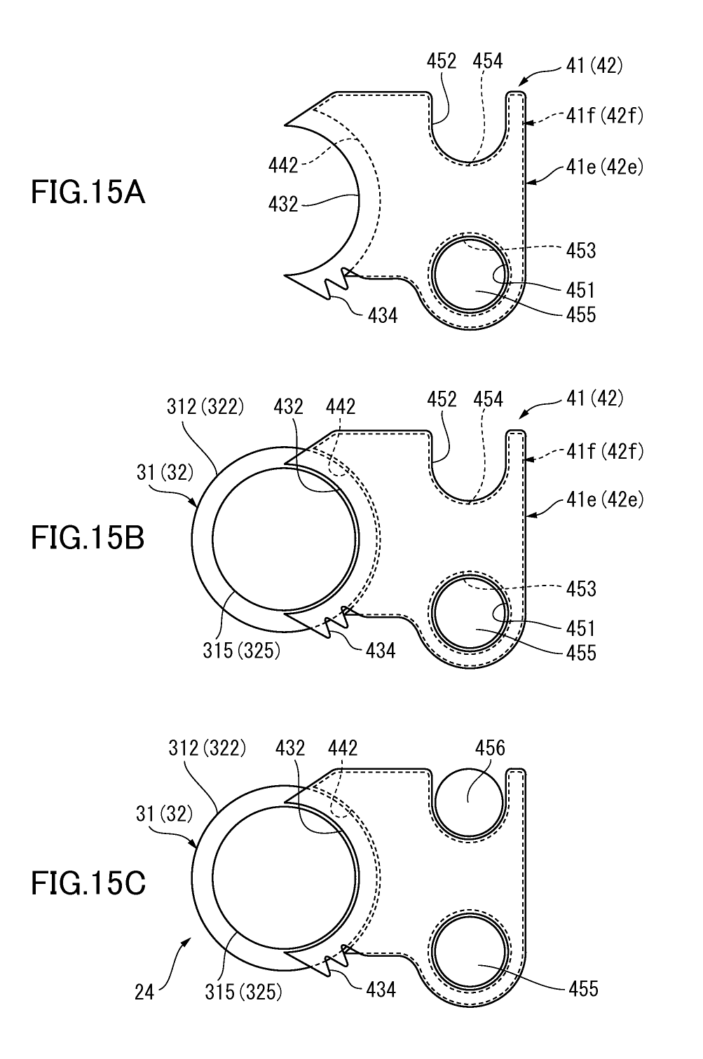

In this embodiment, in the positioning mechanism 47, a circular positioning hole 451 is opened at an arbitrary position (in this embodiment, a lower corner portion on a side away from the blade drum 31 (or 32)) in the partition body 431 of each of the first partition members 41e (or 42e). A U-shaped positioning groove 452 is formed at a part away from the positioning hole 451 (in this embodiment, the upper side portion of the partition body 431, which is located right above the positioning hole 451). In addition, in the partition body 441 of each of the second partition members 41f (or 42f), a positioning hole 453 and a positioning groove 454 are formed as counterparts at positions corresponding to the positioning hole 451 and the positioning groove 452 of the first partition members 41e (or 42e). Under a state in which the first partition members 41e (or 42e) and the second partition members 41f (or 42f) are stacked alternately to each other, a first positioning rod 455 (refer to FIGS. 15A to 15C) is inserted through the positioning holes 451 and 453, and a second positioning rod 456 is inserted through the positioning grooves 452 and 454. With this, the first partition members 41e (or 42e) and the second partition members 41f (or 42f) of the scrapers 41 (or 42) are positioned.

—Assembly Process of Shredding Mechanism—

Description is made of an assembly process of the shredding mechanism 24 in this embodiment.

In order to assemble the shredding mechanism 24, the scrapers 41 and 42 need to be assembled to the blade drums 31 and 32 in a pair.

First, as illustrated in FIG. 15A, as the scrapers 41 (or 42), the first partition members 41e (or 42e) and the second partition members 41f (or 42f) are stacked alternately to each other, and then the first positioning rod 455 is inserted through the positioning holes 451 and 453.

In this state, the first partition members 41e (or 42e) and the second partition members 41f (or 42f) are freely pivotable about a position of the first positioning rod 455.

Then, as illustrated in FIG. 15B, around the blade drum 31 (or 32), the first partition members 41e (or 42e) and the second partition members 41f (or 42f) of the scrapers 41 (or 42) are arranged respectively at parts corresponding to the recessed portions 315 (or 325) of the blade drum 31 (or 32) and parts corresponding to the cutter portions 312 (or 322) of the blade drum 31 (or 32).

Next, at a stage when the arrangement of the partition members 41e and 41f (or 42e and 42f) of the scrapers 41 (or 42) is completed, as illustrated in FIG. 15C, the second positioning rod 456 is inserted through the positioning grooves 452 and 454 of the first partition members 41e (or 42e) and the second partition members 41f (or 42f).

In this state, when the positioning rods 455 and 456 are positioned to predetermined positions in the shredder casing 21, the scrapers 41 and 42 are positioned with respect to the blade drums 31 and 32 with reference to the positions of the positioning rods 455 and 456. In this way, the shredding mechanism 24 is installed at a predetermined position in the shredder casing 21.

—Shredding Process by Shredder—

Next, description is made of the shredding process by the shredder according to this embodiment.

When a normal shredding process substantially similar to that in the first embodiment is executed, many of the particles Sa formed by shredding in the meshing region M between the blade drums 31 and 32 in a pair fall downward to be received in the trash container 27.

However, a part of the particles Sa may electrostatically adhere to peripheries of the blade drums 31 and 32.

As a countermeasure, as illustrated in FIGS. 10 to 15C, the scrapers 41 (or 42) in this embodiment include not only the first partition members 41e (or 42e) but also the second partition members 41f (or 42f). Thus, not only the particles Sa in the recessed portions 315 (or 325) between the cutter portions 312 (or 322) of the blade drums 31 and 32, but also the particles Sa adhering to the cutter portions 312 (or 322) are scraped off.

Thus, a risk in that the particles Sa are accumulated while electrostatically adhering to the peripheries of the blade drums 31 and 32 is significantly low.

In particular, in this embodiment, the first partition members 41e and the second partition members 41f (or 42e and 42f) respectively form, over a wide range, the edge surfaces 432 and 442 that are close respectively to the bottom surfaces of the recessed portions 315 (or 325) and the distal end outer rims of the cutter portions 312 (or 332) of the blade drum 31 (or 32). Thus, the particles Sa electrostatically adhering to peripheral surfaces of the blade drums 31 and 32 do not pass through minute gaps between the blade drums 31 and 32 and the partition members 41e and 42e (or 41f and 42f).

Further, in this embodiment, the first partition members 41e (or 42e) each include the guide piece 434 as illustrated in FIGS. 12A and 12B. Thus, the particles Sa electrostatically adhering to the peripheral surfaces of the blade drums 31 and 32 strike against the guide piece 434, and then are guided downward. In particular, the guide piece 434 includes the two guide projections 435 and 436, and the V-groove 438 is formed between the guide projections 435 and 436. Thus, even when the particles Sa electrostatically adhere near the guide piece 434, the particles Sa fall near the V-groove 438. In this way, a risk in that the particles Sa are left as they are near the guide piece 434 is significantly low.

### Third Embodiment

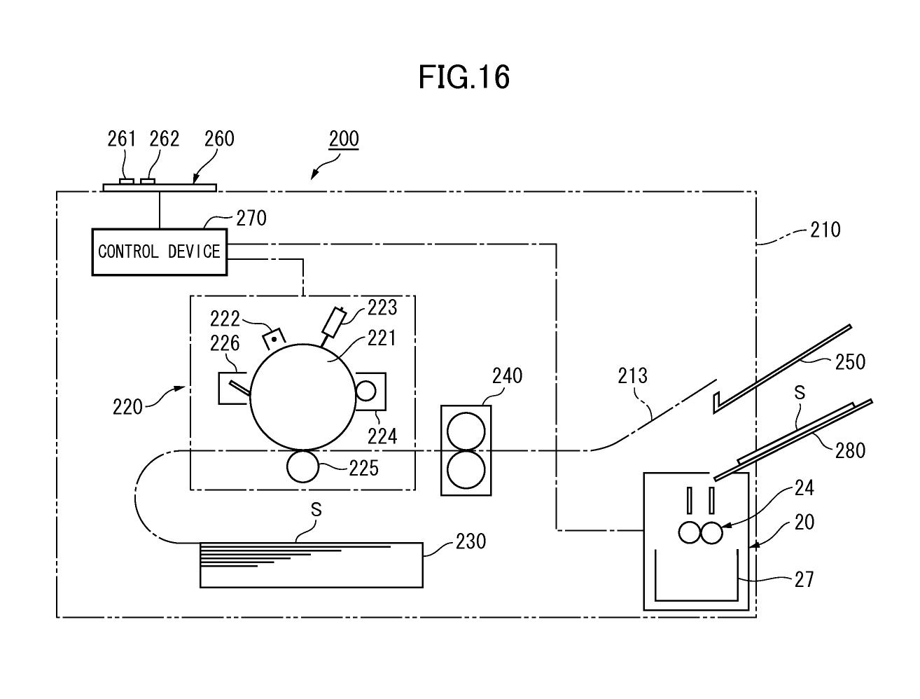

FIG. 16 is an explanatory view of a main part of an image forming apparatus according to a third embodiment of the present invention.

In FIG. 16, an image forming apparatus 200 has an apparatus casing 210 in which the shredder 20 is installed.

In this embodiment, the image forming apparatus 200 has a basic configuration in which the apparatus casing 210 includes therein an image forming unit 220 capable of forming electrophotographic images. Sheets S fed from a sheet feeding tray 230 are conveyed along a predetermined conveying path 213 up to the image forming unit 220, and images formed in the image forming unit 220 are transferred onto the sheets S. Then, the images are fixed to the sheets S by a fixing device 240, for example, of a heating-and-pressing type. Note that, a sheet receiving tray for receiving the sheets S having images formed thereon by a normal image forming process in the image forming unit 220 is denoted by the reference symbol 250.

Further, the image forming unit 220 includes, around a photosensitive member 221, a charging device 222 for charging the photosensitive member 221, an exposure device 223 for forming the electrostatic latent images on the charged photosensitive member 221, a developing device 224 for developing the electrostatic latent images formed on the photosensitive member 221 into visible images with toner, a transfer device 225 for electrostatically transferring the images (toner images), which are formed on the photosensitive member 221, onto the sheets S, and a cleaning device 226 for cleaning residual matter on the photosensitive member 221 after the transfer.

Still further, in this embodiment, with respect to the shredder 20 installed in the apparatus casing 210, a sheet guide tray 280 for guiding sheets S into the shredder 20 is provided, for example, on a lateral side of the apparatus casing 210. With this, the sheets S to be shredded are guided from the sheet guide tray 280 into the shredder 20.

Any of the shredders 20 used as in the first and second embodiments and in the modification may be used as the shredder 20 used in this embodiment.

In addition, the apparatus casing 210 includes an operation panel 260 of the image forming apparatus 200. The operation panel 260 includes not only an image forming operation portion 261 for executing the normal image forming process, but also a shredding operation portion 262 for the shredder 20 (equivalent, for example, to the operation panel 60 in the first embodiment). A control device 270 for controlling the image forming apparatus 200 in response to operations to the operation panel 260 is further provided.

Next, description is made of operation of the image forming apparatus according to this embodiment.

In FIG. 16, when the image forming operation portion 261 of the operation panel 260 is operated, the control device 270 transmits, in accordance with an image forming mode, control signals necessary for image formation to the image forming unit 220, the sheet feeding tray 230, the fixing device 240, and the conveying system for the sheets S so as to execute a series of image forming process.

On the other hand, under a state in which the sheets S to be shredded are set to the sheet guide tray 280, when the shredding operation portion 262 of the operation panel 260 is operated so that the sheets S are fed into the shredder 20, the normal shredding process on the sheets S, processes to be executed depending on whether or not the maintenance is needed, or the process in the cleaning mode is executed in accordance with demand from a user.

In this embodiment, the shredder 20 is installed in the image forming apparatus 200. Thus, there is an advantage in that, even when the image forming process by the image forming unit 220 fails to be properly executed on some of the sheets S, the shredding process can be immediately executed by the shredder 20.

What is claimed is:

1. A shredder, comprising:
a shredding mechanism for shredding a sheet-like object, the shredding mechanism being provided in a midway of a conveying path through which the sheet-like object is inserted;
a drive device for driving the shredding mechanism; and
a control device for controlling the drive device,
the shredding mechanism comprising:
a first blade drum comprising cutter portions formed around a rotatable drum body, the cutter portions each comprising cutting blades formed at a predetermined pitch in a rotation direction of the rotatable drum body, the cutter portions being integrally formed by a cutting-out process through intermediation of recessed portions at a predetermined clearance along a direction of a rotary shaft of the rotatable drum body;
a second blade drum comprising cutter portions formed around a rotatable drum body, the cutter portions each comprising cutting blades formed at a predetermined pitch in a rotation direction of the rotatable drum body, the cutter portions being integrally formed by the cutting-out process through intermediation of recessed portions at a predetermined clearance along a direction of a rotary shaft of the rotatable drum body,
the first blade drum and the second blade drum being configured to mesh with each other in a manner that the cutter portions of the second blade drum bite into the recessed portions of the first blade drum, and that the cutter portions of the first blade drum bite into the recessed portions of the second blade drum; and
a plurality of scraping members for scraping off particles formed by shredding in a meshing region between the first blade drum and the second blade drum in a pair from an inside of the recessed portions located between the cutter portions of the first blade drum and from an inside of the recessed portions located between the cutter portions of the second blade drum, the plurality of scraping members being arranged so as to bite into the recessed portions of the first blade drum and into the recessed portions of the second blade drum in a region out of the meshing region between the first blade drum and the second blade drum in a pair,
the control device comprising a determination unit for determining a jam condition of the particles in the shredding mechanism based on a load applied to the drive device during idling of the shredding mechanism, which is carried out by driving the drive device under a state in which the sheet-like object to be shredded is not conveyed in the shredding mechanism.

2. A shredder according to claim 1, wherein the plurality of scraping members each have a scraping surface conforming to a shape of a bottom surface of each of the recessed portions of corresponding one of the first blade drum and the second blade drum.

3. A shredder according to claim 1 or 2, wherein one or two of the plurality of scraping members are provided so as to face each of the first blade drum and the second blade drum, the one or two of the plurality of scraping members being regulated in position with respect to corresponding one of the first blade drum and the second blade drum by two position regulating members so that amounts of biting into the recessed portions of the corresponding one of the first blade drum and the second blade drum are regulated.

4. A shredder according to claim 1, wherein the plurality of scraping members comprise:
first partition members placed so as to remove the particles formed by shredding in the meshing region between the first blade drum and the second blade drum in a pair from the inside of the recessed portions of the first blade drum and from the inside of the recessed portions of the second blade drum, the first partition members being arranged in a plurality of stages in the region out of the meshing region between the first blade drum and the second blade drum in a pair so as to cover peripheries of the recessed portions of the first blade drum and peripheries of the recessed portions of the second blade drum; and
second partition members placed so as to close gaps through which the particles formed by shredding in the meshing region between the first blade drum and the second blade drum in a pair enter between the first partition members, the second partition members being arranged in a plurality of stages in the region out of the meshing region between the first blade drum and the second blade drum in a pair so as to cover peripheries of the cutter portions of the first blade drum and peripheries of the cutter portions of the second blade drum.

5. A shredder according to claim 1,
wherein the drive device comprises a drive source for driving the first blade drum and the second blade drum in a pair in the shredding mechanism, and
wherein the determination unit of the control device is configured to grasp the load applied to the drive device by detecting drive current of the drive source.

6. A shredder according to claim 1, wherein the control device comprises a maintenance determination unit for determining, based on results of determination by the determination unit, whether or not the jam condition of the particles in the shredding mechanism necessitates maintenance of the shredding mechanism.

7. A shredder according to claim 1,
wherein the drive device comprises a drive source for rotating the first blade drum and the second blade drum in a pair in the shredding mechanism forward and reversely,
wherein the control device comprises a cleaning mode determination unit for determining, based on results of determination by the determination unit, whether or not the jam condition of the particles in the shredding mechanism necessitates execution of a cleaning mode for the shredding mechanism, and
wherein the control device executes a cleaning process comprising at least one reverse rotation of the drive source in a case where the cleaning mode needs to be executed.

8. A sheet-like-object processing apparatus, comprising:
a processing unit for processing a sheet-like object; and
the shredder according to claim 1, the shredder being configured to shred the sheet-like object in a case where a process by the processing unit has failed to be properly executed on the sheet-like object.
